(19) United States
(12) Patent Application Publication
(10) Pub. No.: US 2017/0017305 A1
(43) Pub. Date: Jan. 19, 2017

(54) ELECTRONIC DEVICE AND METHOD FOR CONTROLLING THE SAME

(71) Applicant: Samsung Electronics Co., Ltd., Suwon-si (KR)

(72) Inventors: Jung-Bum HUR, Seongnam-si (KR); Sung-Jin KIM, Seoul (KR); Yong-Chan KEH, Seoul (KR); Sung-Soon KIM, Seoul (KR); Ju-Yeoung KIM, Gunpo-si (KR); Hyo-Won KIM, Bucheon-si (KR); Byeong-Hoon PARK, Suwon-si (KR); Ki-Suk SUNG, Yongin-si (KR); Sae-Gee OH, Goyang-si (KR); Sang-Yoon LEE, Seoul (KR); Jung-Kee LEE, Osan-si (KR); Soe-Youn YIM, Seoul (KR)

(21) Appl. No.: 15/211,322

(22) Filed: Jul. 15, 2016

Related U.S. Application Data
(60) Provisional application No. 62/192,843, filed on Jul. 15, 2015.

(30) Foreign Application Priority Data
Jul. 5, 2016 (KR) 10-2016-0084844

(51) Int. Cl. G06F 3/01; H04N 13/02; H04N 9/31

(52) U.S. Cl. CPC G06F 3/017; H04N 9/3141; H04N 9/3185; H04N 13/0207; H04N 13/0271

(57) ABSTRACT

An apparatus and a method for controlling an electronic device are provided. The electronic device includes a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a transceiver communicable with the external electronic device, and a processor. The processor is configured to control for receiving the content from the external electronic device, outputting the content using the beam projector, and adjusting a direction in which the mirror is positioned according to a rotation control signal on the mirror received from the external electronic device through the transceiver or received through the input unit to adjust a direction in which the content is reflected.

### CROSS-REFERENCE TO RELATED APPLICATION(S)

This application claims the benefit under 35 U.S.C. §119(e) of a U.S. Provisional application filed on Jul. 15, 2015 in the U.S. Patent and Trademark Office and assigned Ser. No. 62/192,843, and under 35 U.S.C. §119(a) of a Korean patent application filed on Jul. 5, 2016 in the Korean Intellectual Property Office and assigned Serial number 10-2016-0084844, the entire disclosure of each of which is hereby incorporated by reference.

### TECHNICAL FIELD

The present disclosure relates to electronic devices. More particularly, the present disclosure relates to electronic devices that output contents based on depth information on a user's gesture and methods for controlling the same.

### BACKGROUND

Keyboards, computer mice, and touchpads have been used as means for interfacing between users and electronic devices based on personal computers (PCs).

Accordingly, there has been motion sensing technology which uses two-dimensional (2D) cameras or illumination sensors for proper entry into electronic devices by users who are human beings. However, its usability has been limited by failure to precisely extract depth information on the user's motion.

In methods for accurate motion sensing according to the related art, the electronic device computes a depth map using a depth sensor, extracts skeleton data on three-dimensional coordinates (X, Y, Z) based on the depth map, and extracts depth information on the user's motion. Methods for sensing the distance between the electronic device and the user to compute the depth map include, e.g., structured light (SL), time-of-flight (ToF), stereoscopic cameras, and arrayed cameras, which have been applied to such products as Microsoft Kinect, Intel RealSense, or Leapfrog Leap television (TV).

Generally, the use of a single 2D camera or illumination sensor has its own limitation due to failure to obtain distance information, and motion sensing systems utilizing SL, ToF, stereoscopic cameras or arrayed cameras require, for use, connection with a TV through a PC or running on a laptop computer.

Motion sensing devices of the related art are installed or designed to adopt a face-to-face or top down projection for exact motion sensing. Thus, such a motion sensing device of the related art may subject unskilled users to difficulty upon installation, and once installed in the place where a display for outputting contents based on motion sensing is positioned, it should remain unchanged in place for use.

Further, the motion sensing device of the related art conducts computation based on distance data or raw image data decoded by a single processor. For those reasons, the whole computation process for motion sensing concentrates onto the single processor, and thus, the limitations in power consumption and processor performance renders it difficult for the device to expand to a portable one. Meanwhile, external motion sensing devices of the related art transmit all the data to the processor of an external electronic device (e.g., a smartphone) so that the processor of the external electronic device processes the data. Limited bandwidths in the transmission lines impose a difficulty in transmission of high-resolution raw image data or raw data from several image sensors. Further, embedded or stand-alone motion sensing devices according to the related art, although not raising any issues regarding transmission lines, may increase the latency or power consumption as more data is communicated. Further, since all the computation process for motion sensing should be done by a single processor, the processor occupancy may rise due to depth and skeleton computation, resulting in increased power consumption, insufficient processing resources for applications, and retarded execution.

Meanwhile, in light of motion sensing processing, the legacy motion sensing devices do not make a distinction as to the type of user, i.e., does not differentiate between child and adult, and thus bring about an inefficient motion sensing process and increased load of computation. No user distinction renders it difficult to create specified applications for use by children, adults, or both. In particular, child users need assistance until they are used to skillfully manipulating a device, but the devices of the related art do not take that in consideration.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device that allows children to freely use and enjoy contents controlled based on motion sensing while ether on the move or stationary and provides simplified installation and use without any restriction on use environment or installation.

An aspect of the present disclosure is to provide a method for controlling an electronic device that may change the subject processing the computation of the electronic device, and allow some of the data required for an application to be previously computed and mapped by the electronic device and send to an external electronic device (e.g., a smartphone), thereby reducing the amount of data on the transmission lines and the computation load of the processor.

An aspect of the present disclosure is to provide a device and method that may differentiate users and set different motion sensing regions to the users, respectively, to reduce the task load of the processor of the external electronic device, thereby allowing for efficient support for applications specified for user scenarios. In particular, the device and method may allow parents to assist their children in reducing malfunctions or errors that may arise when the children use the device.

In accordance with an aspect of the present disclosure, an electronic device is provided. The electronic device includes a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a transceiver communicable with the external electronic device, and a processor configured to control for receiving the content from the external electronic device, outputting the content using the beam projector, receiving a rotation control signal on the mirror through the transceiver from the external electronic device or through the input unit and adjusting a direction in which the mirror is positioned according to the rotation control signal to adjust a direction in which the content is reflected.

In accordance with an aspect of the present disclosure, a method for controlling an electronic device is provided. The electronic device includes a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a transceiver communicable with the external electronic device, and a processor may comprise receiving the content from the external electronic device, outputting the content using the beam projector, receiving a rotation control signal on the mirror through the transceiver from the external electronic device or through the input unit, and adjusting a direction in which the mirror is positioned according to the rotation control signal to adjust a direction in which the content is reflected.

According to an aspect of the present disclosure, the electronic device may be used in a narrow space even without separate preparations, such as a height-adjustable table.

The electronic device may provide easy installation and contents for children.

Further, the electronic device may provide calibrated motion-related data against camera distortions.

Further, the electronic device may provide calibrated skeleton data for the motion input region and thus rely less on the calibration of skeleton data that should be processed on the application end, secure a basic level of motion control, and allow contents developers an environment for easier creation of contents.

Other aspects, advantages, and salient features of the disclosure will become apparent to those skilled in the art from the following detailed description, which, taken in conjunction with the annexed drawings, disclose various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a use environment of a plurality of electronic devices according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIGS. 4A and 4B are a perspective front view and a rear view illustrating an electronic device according to an embodiment of the present disclosure;

FIG. 5 is a side view illustrating an electronic device according to an embodiment of the present disclosure;

FIG. 6 illustrates a beam projector and a mirror according to an embodiment of the present disclosure;

FIG. 7 is a block diagram illustrating an electronic device and an external electronic device according to an embodiment of the present disclosure;

FIG. 8 is a flowchart that illustrates a method for controlling an electronic device according to an embodiment of the present disclosure; and

FIG. 9 is a flowchart that illustrates a method for controlling an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural references unless the context clearly dictates otherwise. Thus, for example, reference to “a component surface” includes reference to one or more of such surfaces.

As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), a Moving Picture Experts Group phase 1 or phase 2 (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, examples of the smart home appliance may include at least one of a television (TV), a digital versatile disc (DVD) player, an audio player, a refrigerator, an air conditioner, a cleaner, an oven, a microwave oven, a washer, a dryer, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs) of financial organizations, point of sales (POS) devices of stores, or Internet of things devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves). According to embodiments of the present disclosure, the electronic device may be flexible or may be a combination of the above-enumerated electronic devices. According to an embodiment of the present disclosure, the electronic device is not limited to the above-listed embodiments. As used herein, the term “user” may denote a human or another device (e.g., an artificial intelligent electronic device) using the electronic device.

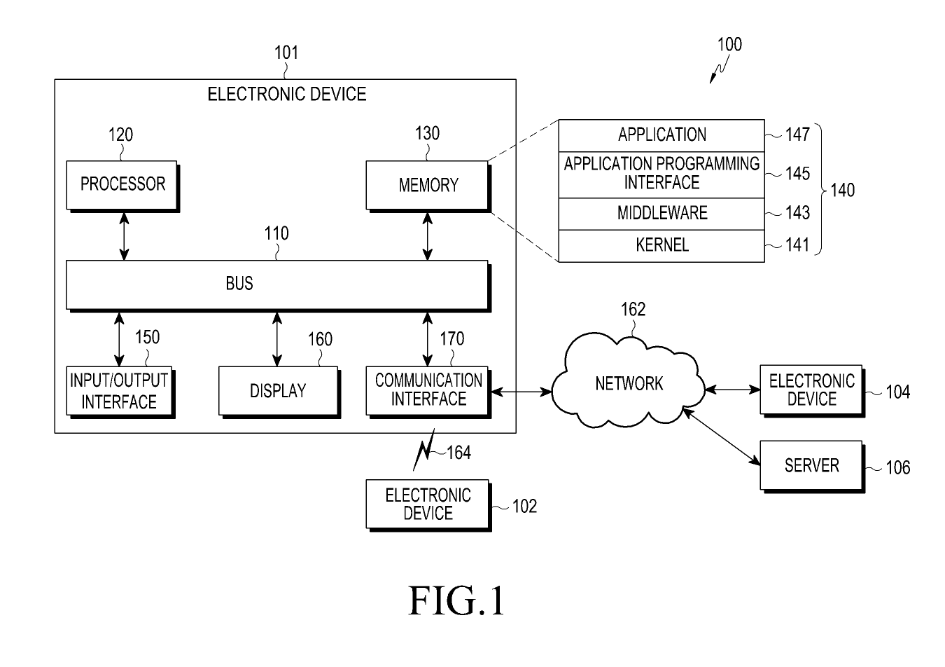

FIG. 1 is a view illustrating a use environment of a plurality of electronic devices according to an embodiment of the present disclosure.

Referring to FIG. 1, according to an embodiment of the present disclosure, an electronic device 101 is included in a network environment 100. The electronic device 101 may include a bus 110, a processor 120, a memory 130, an input/output interface 150, a display 160, and a communication interface 170. In some embodiments, the electronic device 101 may exclude at least one of the components or may add another component. The bus 110 may include a circuit for connecting the components 110 to 170 with one another and transferring communications (e.g., control messages or data) between the components. The processing module 120 may include one or more of a central processing unit (CPU), an application processor (AP), or a communication processor (CP). The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS). For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. Further, the middleware 143 may process one or more task requests received from the application program 147 in order of priority. For example, the middleware 143 may assign a priority of using system resources (e.g., bus 110, processor 120, or memory 130) of the electronic device 101 to at least one of the application programs 147 and process one or more task requests. The API 145 is an interface allowing the application 147 to control functions provided from the kernel 141 or the middleware 143. For example, the API 145 may include at least one interface or function (e.g., a command) for filing control, window control, image processing or text control. For example, the input/output interface 150 may transfer commands or data input from the user or other external device to other component(s) of the electronic device 101 or may output commands or data received from other component(s) of the electronic device 101 to the user or other external devices.

The display 160 may include, e.g., a liquid crystal display (LCD), a light emitting diode (LED) display, an organic LED (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user. For example, the communication interface 170 may set up communication between the electronic device 101 and an external electronic device (e.g., a first electronic device 102, a second electronic device 104, or a server 106). For example, the communication interface 170 may be connected with the network 162 through wireless communication 164 or wired communication to communicate with the external electronic device (e.g., the second external electronic device 104 or server 106), as illustrated in FIG. 1.

The wireless communication may include cellular communication using at least one of, e.g., long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). According to an embodiment of the present disclosure, the wireless communication may include at least one of, e.g., Wi-Fi, Bluetooth (BT), BT low power (BLE), ZigBee, near field communication (NFC), magnetic secure transmission (MST), radio frequency (RF), or body area network (BAN). According to an embodiment of the present disclosure, the wireless communication may include global navigation satellite system (GNSS). The GNSS may be, e.g., global positioning system (GPS), global navigation satellite system (GLONASS), BeiDou navigation satellite system (hereinafter, “BeiDou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present disclosure, all or some of operations executed on the electronic device 101 may be executed on another or multiple other electronic devices (e.g., the electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

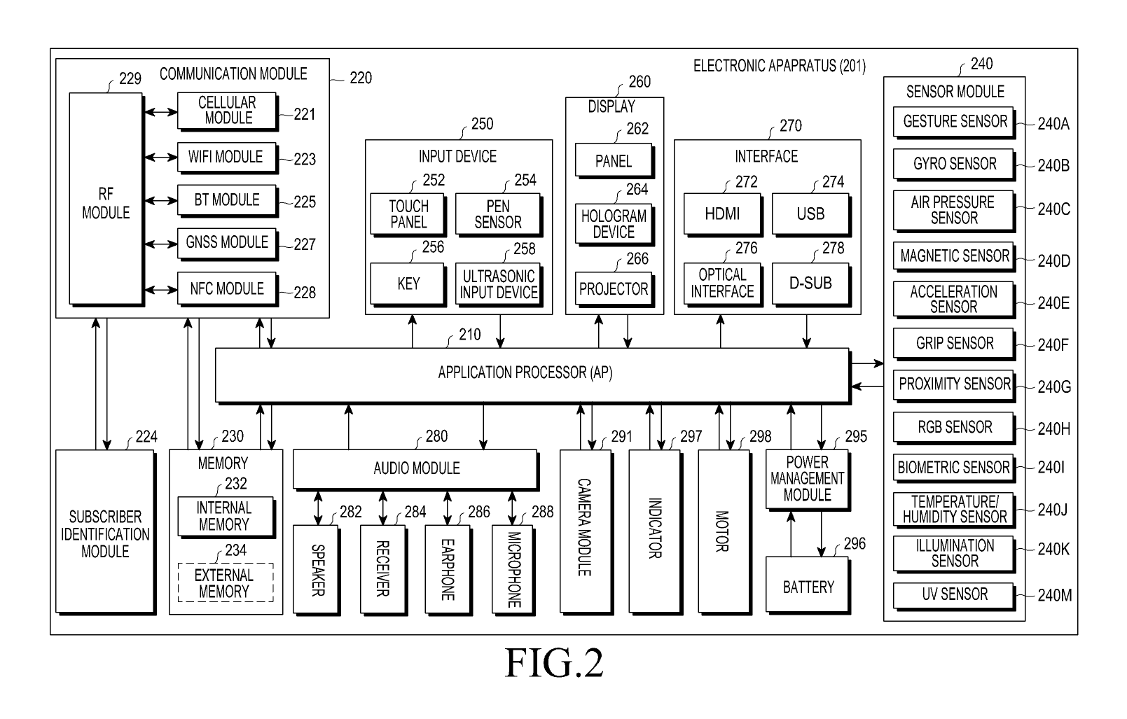

FIG. 2 is a block diagram illustrating an electronic device 201 according to an embodiment of the present disclosure.

Referring to FIG. 2, the electronic device 201 may include the whole or part of the configuration of, e.g., the electronic device 101 shown in FIG. 1. The electronic apparatus or device 201 may include one or more processors (e.g., application processors (APs)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control multiple hardware and software components connected to the processor 210 by running, e.g., an OS or application programs, and the processor 210 may process and compute various data. The processor 210 may be implemented in, e.g., a system on chip (SoC). According to an embodiment of the present disclosure, the processor 210 may further include a graphics processing unit (GPU) and/or an image signal processor (ISP). The processor 210 may include at least some (e.g., the cellular module 221) of the components shown in FIG. 2. The processor 210 may load a command or data received from at least one of other components (e.g., a non-volatile memory) on a volatile memory, process the command or data, and store resultant data in the non-volatile memory.

The communication module 220 may have the same or similar configuration to the communication interface (e.g., the communication interface 170) of FIG. 1. The communication module 220 may include, e.g., a cellular module 221, a Wi-Fi module 223, a BT module 225, a GNSS module 227, a NFC module 228, and an RF module 229. The cellular module 221 may provide voice call, video call, text, or internet services through, e.g., a communication network. The cellular module 221 may perform identification or authentication on the electronic device 201 in the communication network using a SIM 224 (e.g., the SIM card). According to an embodiment of the present disclosure, the cellular module 221 may perform at least some of the functions providable by the processor 210. According to an embodiment of the present disclosure, the cellular module 221 may include a communication processor (CP). According to an embodiment of the present disclosure, at least some (e.g., two or more) of the cellular module 221, the Wi-Fi module 223, the BT module 225, the GNSS module 227, or the NFC module 228 may be included in a single integrated circuit (IC) or an IC package. The RF module 229 may communicate data, e.g., communication signals (e.g., RF signals). The RF module 229 may include, e.g., a transceiver, a power amplifier module (PAM), a frequency filter, a low noise amplifier (LNA), or an antenna. According to an embodiment of the present disclosure, at least one of the cellular module 221, the Wi-Fi module 223, the BT module 225, the GNSS module 227, or the NFC module 228 may communicate RF signals through a separate RF module. The SIM 224 may include, e.g., a card including a SIM or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic random access memory (DRAM), a static RAM (SRAM), a synchronous dynamic RAM (SDRAM), etc.) or a non-volatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 234 may include a flash drive, e.g., a compact flash (CF) memory, a secure digital (SD) memory, a micro-SD memory, a mini-SD memory, an extreme digital (xD) memory, a multi-media card (MMC), or a memory Stick™. The external memory 234 may be functionally or physically connected with the electronic device 201 via various interfaces.

For example, referring to FIG. 2, the sensor module 240 may measure a physical quantity or detect an operational state of the electronic device 201, and the sensor module 240 may convert the measured or detected information into an electrical signal. The sensor module 240 may include at least one of, e.g., a gesture sensor 240A, a gyro sensor 240B, an atmospheric pressure sensor or air pressure sensor 240C, a magnetic sensor 240D, an acceleration sensor 240E, a grip sensor 240F, a proximity sensor 240G, a color sensor 240H (e.g., a red-green-blue (RGB) sensor, a bio or biometric sensor 240I, a temperature/humidity sensor 240J, an illumination sensor 240K, or an ultra-violet (UV) sensor 240M. Additionally or alternatively, the sensing module 240 may include, e.g., an electronic nose (e-nose sensor), an electromyography (EMG) sensor, an electroencephalogram (EEG) sensor, an electrocardiogram (ECG) sensor, an infrared (IR) sensor, an iris sensor, or a finger print sensor (not shown). The sensor module 240 may further include a control circuit for controlling at least one or more of the sensors included in the sensing module. According to an embodiment of the present disclosure, the electronic device 201 may further include a processor configured to control the sensor module 240 as part of the processor 210 or separately from the processor 210, and the electronic device 2701 may control the sensor module 240 while the processor 210 is in a sleep mode.

The input unit 250 may include, e.g., a touch panel 252, a (digital) pen sensor or digital stylus 254, a key 256, or an ultrasonic input device 258. The touch panel 252 may use at least one of capacitive, resistive, infrared, or ultrasonic methods. The touch panel 252 may further include a control circuit. The touch panel 252 may further include a tactile layer and may provide a user with a tactile reaction. The (digital) pen sensor 254 may include, e.g., a part of a touch panel or a separate sheet for recognition. The key 256 may include e.g., a physical button, optical key or key pad. The ultrasonic input device 258 may sense an ultrasonic wave generated from an input tool through a microphone (e.g., the microphone 288) to identify data corresponding to the sensed ultrasonic wave.

The display 260 (e.g., the display 160) may include a panel 262, a hologram device 264, a projector 266, and/or a control circuit for controlling the same. The panel 262 may be implemented to be flexible, transparent, or wearable. The panel 262, together with the touch panel 252, may be configured in one or more modules. According to an embodiment of the present disclosure, the panel 262 may include a pressure sensor (or pose sensor) that may measure the strength of a pressure by the user's touch. The pressure sensor may be implemented in a single body with the touch panel 252 or may be implemented in one or more sensors separate from the touch panel 252. The hologram device 264 may make three dimensional (3D) images (holograms) in the air by using light interference. The projector 266 may display an image by projecting light onto a screen. The screen may be, for example, located inside or outside of the electronic device 201. The interface 270 may include e.g., an HDMI 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition Link (MHL) interface, an SD card/MMC interface, or infrared data association (IrDA) standard interface.

The audio module 280 may convert, e.g., a sound signal into an electrical signal and vice versa. At least a part of the audio module 280 may be included in e.g., the input/output interface 145 as shown in FIG. 1. The audio module 280 may process sound information input or output through e.g., a speaker 282, a receiver 284, an earphone 286, or a microphone 288. For example, the camera module 291 may be a device for capturing still images and videos, and may include, according to an embodiment of the present disclosure, one or more image sensors (e.g., front and back sensors), a lens, an ISP, or a flash such as an LED or xenon lamp. The power manager module 295 may manage power of the electronic device 201, for example. According to an embodiment of the present disclosure, the power manager module 295 may include a power management integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal to a mechanical vibration and may generate a vibrational or haptic effect. The electronic device 201 may include a mobile TV supporting device (e.g., a GPU) that may process media data as per, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments, the electronic device (e.g., the electronic device 201) may exclude some elements or include more elements, or some of the elements may be combined into a single entity that may perform the same function as by the elements before combined.

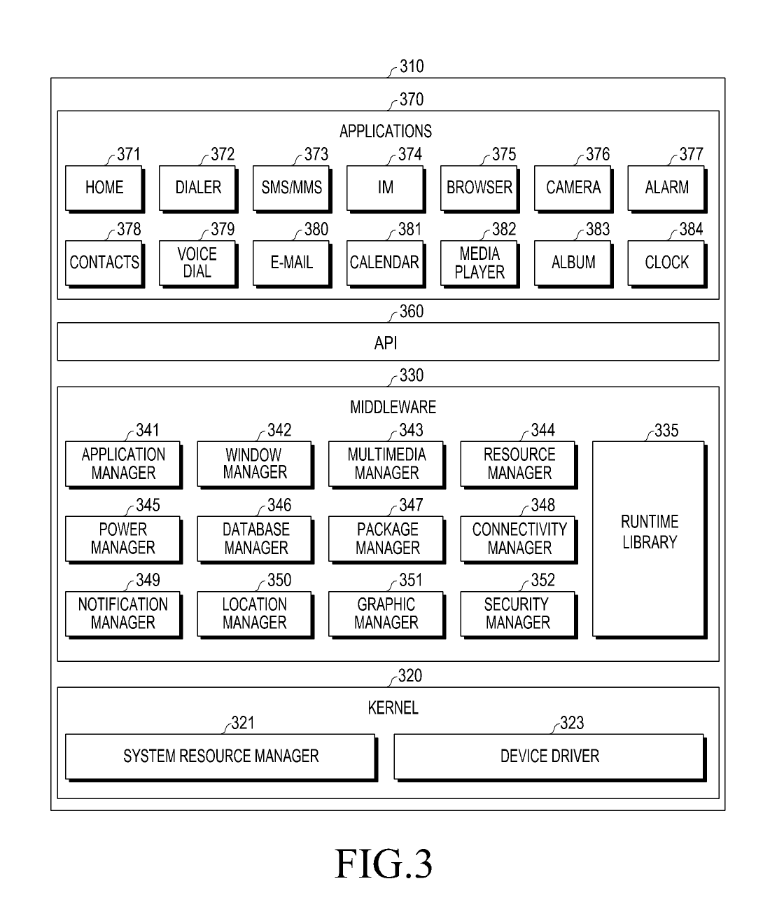

FIG. 3 is a block diagram illustrating a program module according to an embodiment of the present disclosure.

Referring to FIG. 3, according to an embodiment of the present disclosure, the program module 310 (e.g., the program 140) may include an operating system (OS) for controlling resources related to the electronic device (e.g., the electronic device 101) and/or various applications (e.g., the application processor 147) driven on the OS. The OS may include, e.g., Android™, iOS™, Windows™, Symbian™, Tizen™, or Bada™. Referring to FIG. 3, the program module 310 may include a kernel 320 (e.g., the kernel 141), middleware 330 (e.g., the middleware 143), an API 360 (e.g., the API 145), and/or an application 370 (e.g., the application program 147). At least a part of the program module 310 may be preloaded on the electronic device or may be downloaded from an external electronic device (e.g., the electronic devices 102 and 104 or server 106).

The kernel 320 may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a BT driver, a shared memory driver, a USB driver, a keypad driver, a Wi-Fi driver, an audio driver, or an inter-process communication (IPC) driver. The middleware 330 may provide various functions to the application 370 through the API 360 so that the application 370 may use limited system resources in the electronic device or provide functions jointly required by applications 370. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or arithmetic function processing. The application manager 341 may manage the life cycle of, e.g., the applications 370. The window manager 342 may manage graphical user interface (GUI) resources used on the screen. The multimedia manager 343 may grasp formats necessary to play media files and use a codec appropriate for a format to perform encoding or decoding on media files. The resource manager 344 may manage the source code or memory space of the application 370. The power manager 345 may manage, e.g., the battery capability or power and provide power information necessary for the operation of the electronic device. According to an embodiment of the present disclosure, the power manager 345 may interwork with a basic input/output system (BIOS). The database manager 346 may generate, search, or vary a database to be used in the applications 370. The package manager 347 may manage installation or update of an application that is distributed in the form of a package file.

Referring to FIG. 3, the connectivity manager 348 may manage, e.g., wireless connectivity. The notification manager 349 may provide an event, e.g., arrival message, appointment, or proximity alert, to the user. The location manager 350 may manage, e.g., locational information on the electronic device. The graphic manager 351 may manage, e.g., graphic effects to be offered to the user and their related user interface. The security manager 352 may provide system security or user authentication, for example. According to an embodiment of the present disclosure, the middleware 330 may include a telephony manager for managing the voice or video call function of the electronic device or a middleware module able to form a combination of the functions of the above-described elements. According to an embodiment of the present disclosure, the middleware 330 may provide a module specified according to the type of the OS. The middleware 330 may dynamically omit some existing components or add new components. The API 360 may be a set of, e.g., API programming functions and may have different configurations depending on OSs. For example, in the case of Android or iOS, one API set may be provided per platform, and in the case of Tizen, two or more API sets may be offered per platform.

The application 370 may include an application that may provide, e.g., a home 371, a dialer 372, a short message service (SMS)/multimedia message service (MMS) 373, an instant message (IM) 374, a browser 375, a camera 376, an alarm 377, a contact or contacts 378, a voice dial 379, an e-mail 380, a calendar 381, a media player 382, an album 383, or a clock 384, a health-care (e.g., measuring the degree of workout or blood sugar), or provision of environmental information (e.g., provision of air pressure, moisture, or temperature information). According to an embodiment of the present disclosure, the application 370 may include an information exchanging application supporting information exchange between the electronic device and an external electronic device. Examples of the information exchange application may include, but is not limited to, a notification relay application for transferring specific information to the external electronic device, or a device management application for managing the external electronic device. For example, the notification relay application may transfer notification information generated by other application of the electronic device to the external electronic device or receive notification information from the external electronic device and provide the received notification information to the user. For example, the device management application may install, delete, or update a function (e.g., turn-on/turn-off the external electronic device (or some elements) or adjusting the brightness (or resolution) of the display) of the external electronic device communicating with the electronic device or an application operating on the external electronic device. According to an embodiment of the present disclosure, the application 370 may include an application (e.g., a health-care application of a mobile medical device) designated according to an attribute of the external electronic device. According to an embodiment of the present disclosure, the application 370 may include an application received from the external electronic device. At least a portion of the program module 310 may be implemented (e.g., executed) in software, firmware, hardware (e.g., the processor 210), or a combination of at least two or more thereof and may include a module, program, routine, command set, or process for performing one or more functions.

As used herein, the term “module” includes a unit or device configured in hardware, software, or firmware and may be interchangeably used with other term, e.g., a logic, logic block, part, or circuit. The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. The computer-readable medium may include, e.g., a hard disk, a floppy disc, a magnetic medium (e.g., magnetic tape), an optical recording medium (e.g., compact disc ROM (CD-ROM), DVD, magnetic-optical medium (e.g., floptical disk), or an embedded memory. The instruction may include a code created by a compiler or a code executable by an interpreter. Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, in parallel, repeatedly or heuristically, or at least some operations may be executed in a different order or omitted or other operations may be added.

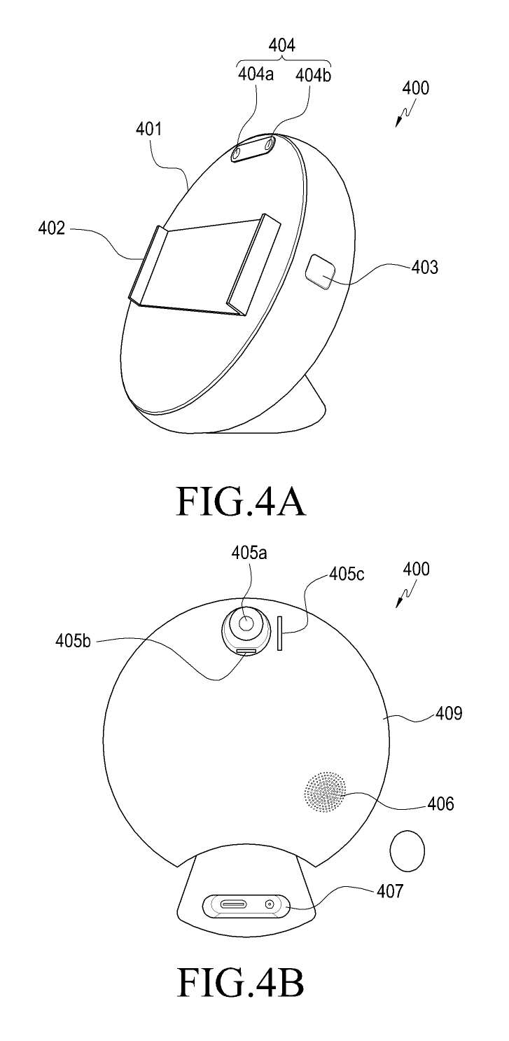

FIGS. 4A and 4B are a perspective front view and a rear view illustrating an electronic device according to an embodiment of the present disclosure.

According to an embodiment of the present disclosure, as shown in FIGS. 4A and 4B, the electronic device 400 may include a housing 401.

According to an embodiment of the present disclosure, the housing 401 may include a first surface 401 and a second surface 409 positioned opposite the first surface 401.

Referring to FIG. 4A, according to an embodiment of the present disclosure, the first surface 401 of the housing may have a holder 402 that allows an external electronic device to be mounted thereon.

According to an embodiment of the present disclosure, the first surface 401 of the housing may include a three-dimensional (3D) camera unit 404 sensing the user positioned at its front side and/or the user's motion to obtain raw image data. According to an embodiment of the present disclosure, the 3D camera unit 404 may include an RGB sensor 404a for obtaining a two-dimensional (2D) raw image for the user's motion and a depth sensor 404b for obtaining depth data on the user's motion.

According to an embodiment of the present disclosure, the housing 401 and 409 may have a connector 403 provided to enable connection with the external electronic device.

Referring to FIG. 4B, according to an embodiment of the present disclosure, the second surface 409 of the housing may include a beam projector 405a outputting contents received from the external electronic device, a mirror 405b, and/or an input unit 405c.

For example, the beam projector 405a may be provided to output contents in a particular direction, the mirror 405b may reflect the output of contents in a direction different from the particular direction, and the input unit 405c may receive a rotation control signal allowing for adjustment of the direction of reflection of the mirror 405b from the user.

According to an embodiment of the present disclosure, the second surface 409 of the housing may include a speaker 406 for outputting a sound corresponding to a content.

According to an embodiment of the present disclosure, the second surface 409 of the housing may include another connector 407 for transmitting contents to another external electronic device (e.g., a TV).

According to an embodiment of the present disclosure, the first surface 401 and the second surface 409 may be flat or curved surfaces.

According to an embodiment of the present disclosure, the second surface 409 may include a first region including the beam projector 405 and the speaker 406 and a second region including the other connector 407.

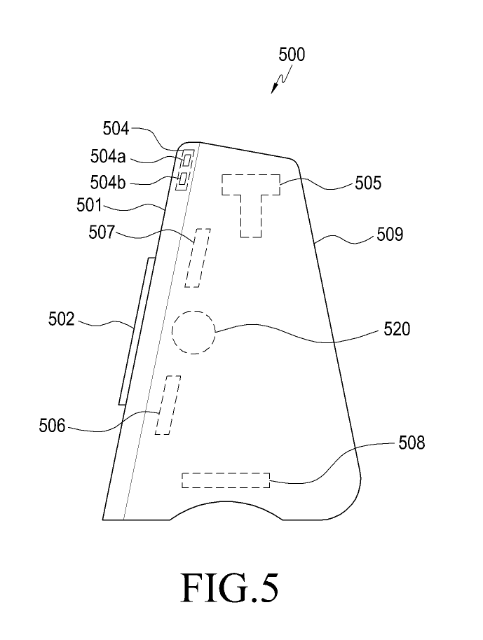

FIG. 5 is a side view illustrating an electronic device according to an embodiment of the present disclosure.

Referring to FIG. 5, according to an embodiment of the present disclosure, the electronic device 500 may include a housing 501 including a first surface 501 and a second surface 509.

According to an embodiment of the present disclosure, the electronic device 500 may include a 3D camera unit 504 for sensing the user's motion, and the 3D camera unit 504 may include an RGB sensor 504a for obtaining a raw 2D image and a depths sensor 504b for obtaining depth data.

According to an embodiment of the present disclosure, the electronic device 500 may include a holder 502 that allows an external electronic device to be mounted thereon.

According to an embodiment of the present disclosure, the electronic device 500 may include a speaker 506 and a heat-radiating fan 508 configured to emit heat from the electronic device to the outside.

According to an embodiment of the present disclosure, the electronic device 500 may include a main printed circuit board (PCB) 520 including a processor for controlling the components of the electronic device.

According to an embodiment of the present disclosure, the electronic device 500 may include a beam projector 505 for outputting contents to the outside.

According to an embodiment of the present disclosure, the 3D camera unit 504 may be disposed in an upper region of the electronic device 500.

According to an embodiment of the present disclosure, the beam projector 505 may be disposed in an upper region of the electronic device 500.

According to an embodiment of the present disclosure, the beam projector 505 and the 3D camera unit 504 may be disposed 20 cm or more above the floor.

According to an embodiment of the present disclosure, the first surface 501 of the housing may be disposed to be inclined upward by five degrees or more.

According to an embodiment of the present disclosure, the 3D camera unit 504 positioned in the first surface 501 may be adjusted for its angle between 20 degrees and −20 degrees.

According to an embodiment of the present disclosure, the first surface 501 may include a USB connection port.

According to an embodiment of the present disclosure, the bottom surface of the electronic device 500 may be flat or curved. According to an embodiment of the present disclosure, the bottom surface of the electronic device 500 may include a space curved to radiate heat.

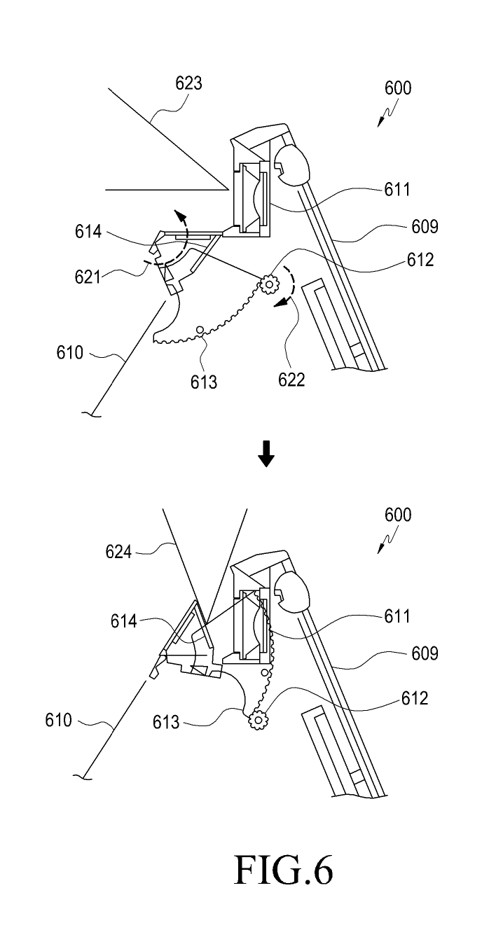

FIG. 6 illustrates a beam projector and a mirror according to an embodiment of the present disclosure.

Referring to FIG. 6, according to an embodiment of the present disclosure, the electronic device 600 may include a second surface 609 of a housing including a beam projector 611 outputting contents in a first direction 623.

According to an embodiment of the present disclosure, the electronic device 600 may include a rotating unit 613 disposed between the first surface 610 and the second surface 609 and rotating in a second direction 621 and a mirror 614 configured to rotate in the second direction 621 as the rotating unit 613 rotate and to reflect contents outputted from the beam projector 611.

According to an embodiment of the present disclosure, the electronic device 600 may include an actuator 612 rotatable in a third direction 622. According to an embodiment of the present disclosure, as the actuator 612 rotates in the third direction 622, the rotating unit 613 and the mirror 614 may be provided to rotate in the second direction 621. According to an embodiment of the present disclosure, the actuator 612 may be a motor. According to an embodiment of the present disclosure, the actuator 612 may be in another form driven by an electrical signal. According to an embodiment of the present disclosure, the actuator 612 may be rotated by an electrical signal.

For example, the electronic device 600 may include a stopper (not shown) to prevent the mirror 614 and the rotating unit 613 from rotating at more than a predetermined angle.

According to an embodiment of the present disclosure, the processor (e.g., the processor 120) of the electronic device 600 may receive a rotation control signal enabling the rotation of the mirror 614 and the rotating unit 613 from an external electronic device (e.g., the external electronic device 102).

According to an embodiment of the present disclosure, the processor 120 may control the mirror 614 and the rotating unit 613 by the received rotation control signal to rotate the rotating unit 613 and adjust the direction where the mirror 614 is positioned.

According to an embodiment of the present disclosure, as the actuator 612 rotates in the third direction 622, the mirror 614 may rotate in the second direction 621, and when the mirror 614 rotates in the second direction 621 to be positioned before the front surface of the beam projector 611, contents outputted from the beam projector 611 may be reflected by the mirror 614 in a fourth direction 624, but not in the first direction 623.

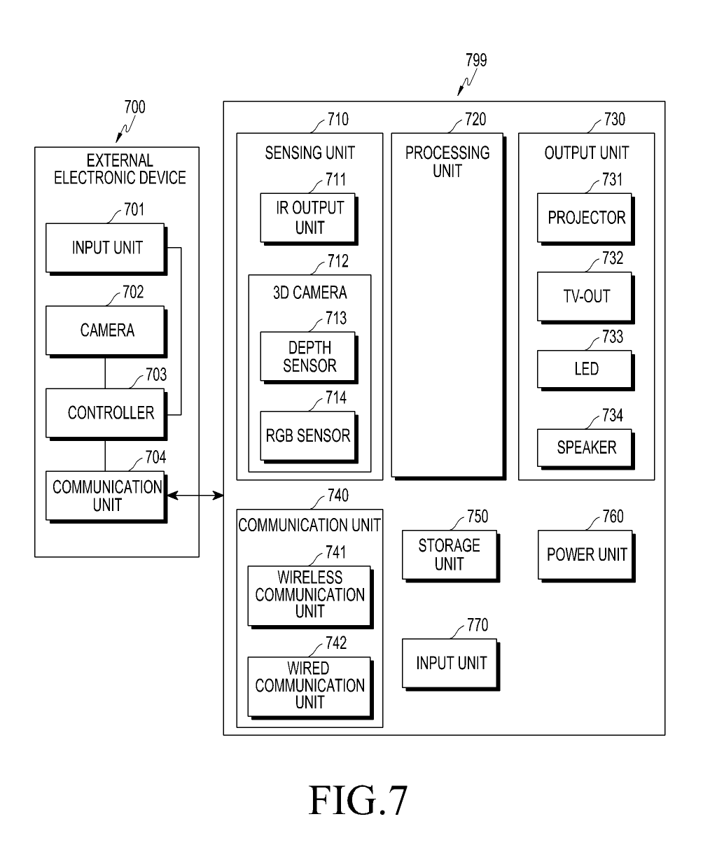

FIG. 7 is a block diagram illustrating an electronic device and an external electronic device according to an embodiment of the present disclosure.

Referring to FIG. 7, according to an embodiment of the present disclosure, the external electronic device 700 may include an input unit 701, a camera 702, a controller 703, and a communication unit (or transceiver) 704.

According to an embodiment of the present disclosure, the input unit 701 of the external electronic device 700 may receive a control input from the user.

According to an embodiment of the present disclosure, the camera 702 may capture an image of a front side of the camera 702.

According to an embodiment of the present disclosure, the controller 703 may perform the same function as the processor (e.g., the processor 120) described above in connection with FIGS. 1 to 3.

According to an embodiment of the present disclosure, the communication unit 704 may transmit contents to the electronic device 799 through wireless or wired communication.

According to an embodiment of the present disclosure, the electronic device 799 may include a sensing unit 710, a processing unit 720, an outputting unit 730, a communication unit 740, a storage unit 750, a power unit 760, and an input unit 770.

According to an embodiment of the present disclosure, the sensing unit 710 may include an IR outputting unit 711 for outputting IR beams and a 3D camera 712 for sensing motion, and the 3D camera 712 may include a depth sensor 713 for obtaining depth data and a RGB sensor 714 for obtaining a raw 2D image.

According to an embodiment of the present disclosure, the processing unit 720 may control the sensing unit 710, outputting unit 730, communication unit 740, storage unit 750, and power unit 760 of the electronic device 799. According to an embodiment of the present disclosure, the processing unit 720 may extract skeleton data using the raw image data received from the sensing unit 710 and process voice inputs and inputs.

According to an embodiment of the present disclosure, the outputting unit 730 may include a projector 731 for outputting contents to the outside, a TV-OUT 732 for outputting to the TV, an LED 733 for outputting LED light, and a speaker 734 for outputting sound.

According to an embodiment of the present disclosure, the storage unit 750 may store contents to be outputted to the outside or the raw image data to be processed by the processing unit 720.

According to an embodiment of the present disclosure, the power unit 760 may supply power to each component in the electronic device 799 and supply power to the external electronic device 700 using a wireless charging scheme.

According to an embodiment of the present disclosure, the processing unit 720 may receive the raw image data from the 3D camera 712, apply the depth data of the raw image data to 2D image data of the raw image data to generate 3D mapping data, output the generated 3D mapping data to the external electronic device 700 using the communication unit 740, and receive content processed using the 3D mapping data by the controller 703 of the external electronic device 700. According to an embodiment of the present disclosure, the processing unit 720 may receive a rotation control signal enabling the rotation of a mirror (e.g., the mirror 614) in the electronic device 799 from the external electronic device 700 using the communication unit 740.

According to an embodiment of the present disclosure, the processing unit 720 may extract skeleton data from the raw image data, transmit the skeleton data to the external electronic device 700, and receive content processed by the controller 703 using the skeleton data.

According to an embodiment of the present disclosure, the processing unit 720 may transmit the raw image data to the external electronic device 700 and receive content processed by the controller 703 using the raw image data.

According to an embodiment of the present disclosure, with reference to FIG. 7, the processing unit 720 may set a motion input region. According to an embodiment of the present disclosure, the processing unit 720 may set a motion input region for sensing the user's motion based on a sensing direction of the 3D camera 712 or an application run on the external electronic device 700, or the user's body information, obtain the raw image data on the user's motion using the set motion input region, and extract skeleton data from the raw image data. For example, the user's body information may include information on one or more of the length of the user's arm or shoulder.

According to an embodiment of the present disclosure, the processing unit 720 may omit the generation of depth data from the raw image data while immediately extracting the skeleton data in order to reduce the computation load of the controller 703. For example, the processing unit 720 may extract the skeleton data using a stereo camera-based convolutional neutral network scheme.

According to an embodiment of the present disclosure, the processing unit 720 may extract a depth standard deviation (STD) value. For example, the processing unit 720 may set a motion input region, obtain the STD of the raw image data in the set motion region, control the IR output of the IR output unit 711, and repeatedly obtain raw image data using the 3D camera 712 while the STD is minimized so that no saturation region occurs for the raw image data.

According to an embodiment of the present disclosure, the input unit 770 may receive a rotation control signal for a mirror (e.g., the mirror 614) from the user or outside and transfer the received rotation control signal to the processing unit 720.

For example, the processing unit 720 may be the same in meaning as a processor.

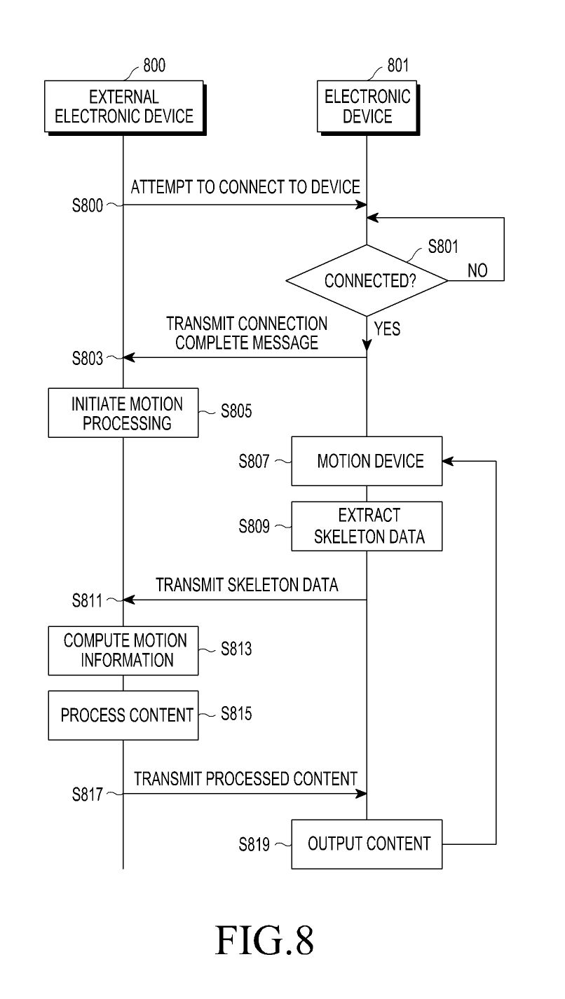

FIG. 8 is a flow chart that illustrates a method for controlling an electronic device according to an embodiment of the present disclosure.

Referring to FIG. 8, according to an embodiment of the present disclosure, the external electronic device 800 may attempt to connect to the electronic device 801 in operation S800. In operation S801, the electronic device 801 may determine whether the external electronic device 800 is connected thereto, and when it is determined that the external electronic device 800 is not normally connected, the electronic device 801 may output a sound for reconnection of the external electronic device 800.

According to an embodiment of the present disclosure, when the external electronic device 800 is normally connected to the electronic device 801 in operation S803, the electronic device 801 may transmit a connection complete message to the external electronic device 800.

According to an embodiment of the present disclosure, in operation S805, the external electronic device 800 may run a motion sensing-based application in the external electronic device 800 and initiate motion processing in the motion sensing-based application.

According to an embodiment of the present disclosure, in operation S807, the electronic device 801 may sense the user's motion using the 3D camera.

According to an embodiment of the present disclosure, in operation S809, the electronic device 801 may obtain raw image data from the sensed motion and extract skeleton data from the raw image data.

According to an embodiment of the present disclosure, in operation S811, the electronic device 801 may transmit the skeleton data to the external electronic device 800.

According to an embodiment of the present disclosure, in operation S813, the electronic device 801 may compute motion data based on the skeleton data, and in operation S815, the electronic device 801 may process contents in the application based on the motion data.

According to an embodiment of the present disclosure, in operation S817, the external electronic device 800 may transmit the processed contents to the electronic device 801, and in operation S819, the electronic device 801 may output the content using the beam projector.

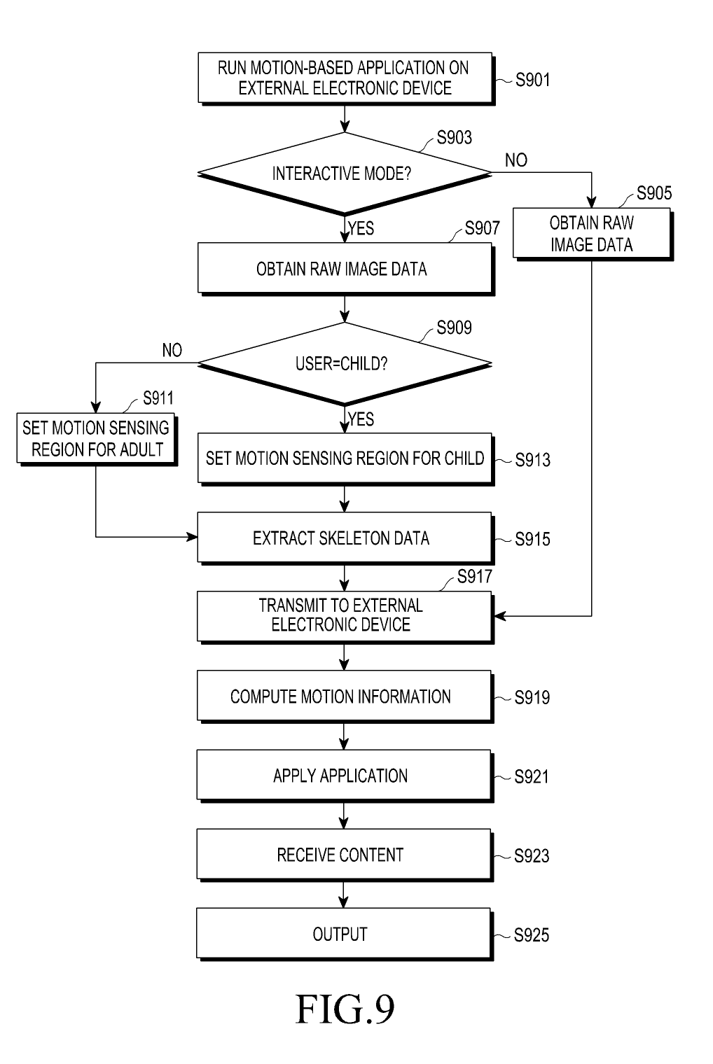

FIG. 9 is a flow chart that illustrates a method for controlling an electronic device according to an embodiment of the present disclosure.

Referring to FIG. 9, according to an embodiment of the present disclosure, in operation S901, an electronic device (e.g., the electronic device 801) may sense the running of a motion-based application on the external electronic device.

According to an embodiment of the present disclosure, in operation S903, the electronic device 801 may determine whether the running mode of the motion-based application run on the external electronic device is an interactive mode.

According to an embodiment of the present disclosure, in operation S905, unless the running mode of the motion-based application is the interactive mode, the electronic device 801 may obtain raw image data, and in operation S917, it may transmit the obtained raw image data to the external electronic device.

According to an embodiment of the present disclosure, in operation S907, when the running mode of the motion-based application is the interactive mode, the electronic device 801 may obtain the raw image data, and in operation S909, it may determine whether the user sensed by the 3D camera is a child. For example, the electronic device 801 may determine whether the user is a child by using the length of the user's arm or shoulder sensed by the 3D camera. For example, when the length of the user's arm or shoulder is smaller than a preset arm length or shoulder length (e.g., in relation to the distance between the user and the electronic device 801), the electronic device 801 may determine that the user is a child.

According to an embodiment of the present disclosure, when the user is determined to be an adult, but not a child, the electronic device 801 may set a motion sensing region for adults in operation S911, and when the user is a child, the electronic device 801 may set a motion sensing region for children in operation S913. For example, the motion sensing region for children and the motion sensing region for adults may have different coordinates, length, and/or width of the start point.

According to an embodiment of the present disclosure, in operation S915, the electronic device 801 may extract skeleton data within the set motion sensing region. For example, the motion sensing region for obtaining the user's motion and a motion may vary depending on the direction where the 3D camera faces the user or the user's body information, and since the motion sensing region varies, the skeleton data extracted therefrom may also vary depending on the user or direction where the 3D camera faces the user.

According to an embodiment of the present disclosure, in operation S917, the electronic device 801 may transmit the skeleton data or raw image data to the external electronic device.

According to an embodiment of the present disclosure, in operation S919, the external electronic device 800 may compute motion information using the skeleton data or raw image data, and in operation 5921, the external electronic device 800 may apply the motion information to a motion-based application.

According to an embodiment of the present disclosure, in operation S923, the electronic device 801 may receive contents from the external electronic device 800, and in operation 5925, it may output the contents using the beam projector.

According to an embodiment of the present disclosure, the view angle of the 3D camera may be 80 degrees horizontal and/or 67 degrees vertical.

According to an embodiment of the present disclosure, the start point of the motion sensing region may be computed by Equations 1 and 2.

StartPoint_X=shoulderCenter X−(shoulderlength/3) Equation 1

StartPoint_Y=shoulderCenter Y−(ROI_H*ROI_SCALE_Y) Equation 2

where, shoulderCenter X and shoulderCenter Y, respectively, are X and Y coordinates of the center of the user's shoulders, ROI_H is the length of the motion sensing region computed by Equation 3 below, and ROI_SCALE_Y is a parameter varying depending on relative positions of the user and the 3D camera.

According to an embodiment of the present disclosure, the length of the motion sensing region may be computed by Equation 3 below.

$${RUI}_{H} = tan ( \frac{a}{2} - b - \frac{π}{4} ) * D ( abs ( kite - user ) ) \qquad Equation 3$$

where, a is the view angle of the 3D camera, b is the angle at which the 3D camera is inclined with respect to the horizontal surface, and D (abs(kite-user)) is the mean length between the user and the 3D camera.

According to an embodiment of the present disclosure, the width of the motion sensing region may be computed by Equation 4 below.

ROI_W=shoulderLength*ROI_SCALE_W Equation 4

where, shoulderLength is the length of the user's shoulder, and ROI_SCALE_W is a parameter varying depending on relative positions of the user and the 3D camera.

According to an embodiment of the present disclosure, an electronic device may comprise a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a communication unit or transceiver communicable with the external electronic device, and a processor. The processor configured to control receiving the content from the external electronic device, outputting the content using the beam projector, receiving a rotation control signal on the mirror through the transceiver from the external electronic device or through the input unit, and adjusting a direction in which the mirror is positioned according to the rotation control signal to adjust a direction in which the content is reflected.

According to an embodiment of the present disclosure, the electronic device may further comprise a rotatable actuator to adjust the direction in which the mirror is positioned, wherein the processor may rotate the actuator according to the rotation control signal.

According to an embodiment of the present disclosure, the electronic device may further comprise a 3D camera positioned in the second surface to sense a user's motion to obtain raw image data.

According to an embodiment of the present disclosure, the processor may further be configured to control setting a motion input region for sensing the motion of the user based on the user's body information.

According to an embodiment of the present disclosure, the processor may further be configured to control setting a motion input region for sensing the motion of the user based on an application run on the external electronic device.

According to an embodiment of the present disclosure, the processor may further be configured to control setting a motion input region for sensing the motion of the user based on a sensing direction of the 3D camera.

According to an embodiment of the present disclosure, the processor may further be configured to control outputting the raw image data to the external electronic device and receiving a content processed using the raw image data from the external electronic device.

According to an embodiment of the present disclosure, the processor may further be configured to control for extracting skeleton data from the raw image data, output the skeleton data to the external electronic device, and receive a content processed using the skeleton data from the external electronic device.

According to an embodiment of the present disclosure, the processor may further be configured to control for applying depth data of the raw image data to 2D image data of the raw image data to generate 3D mapping data, outputting the 3D mapping data to the external electronic device, and receiving a content processed using the 3D mapping data from the external electronic device.

According to an embodiment of the present disclosure, a method for controlling an electronic device comprising a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a communication unit or transceiver communicable with the external electronic device, and a processor may comprise receiving the content from the external electronic device, outputting the content using the beam projector, receiving a rotation control signal on the mirror through the communication unit or transceiver from the external electronic device or through the input unit, and adjusting a direction in which the mirror is positioned according to the rotation control signal to adjust a direction in which the content is reflected.

According to an embodiment of the present disclosure, the method may further comprise sensing a motion of a user to obtain raw image data.

According to an embodiment of the present disclosure, the method may further comprise setting a motion input region for sensing the motion of the user based on the user's body information.

According to an embodiment of the present disclosure, the method may further comprise setting a motion input region for sensing the motion of the user based on an application run on the external electronic device.

According to an embodiment of the present disclosure, the method may further comprise setting a motion input region for sensing the motion of the user based on a sensing direction of a 3D camera provided in the electronic device.

According to an embodiment of the present disclosure, the method may further comprise outputting the raw image data to the external electronic device.

According to an embodiment of the present disclosure, the method may further comprise receiving a content processed using the raw image data from the external electronic device.

According to an embodiment of the present disclosure, the method may further comprise extracting skeleton data from the raw image data.

According to an embodiment of the present disclosure, the method may further comprise outputting the skeleton data to the external electronic device and receiving a content processed using the skeleton data from the external electronic device.

According to an embodiment of the present disclosure, the method may further comprise applying depth data of the raw image data to 2D image data of the raw image data to generate 3D mapping data and outputting the 3D mapping data to the external electronic device.

According to an embodiment of the present disclosure, the method may further comprise receiving a content processed using the 3D mapping data from the external electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a housing;
a holder positioned in a first surface of the housing to mount an external electronic device thereon;
a beam projector positioned in a second surface of the housing;
a mirror positioned between the first surface and the second surface to reflect a content outputted from the beam projector;
an input unit provided in the housing;
a transceiver communicable with the external electronic device; and
a processor configured to control for:
receiving the content from the external electronic device,
outputting the content using the beam projector, receiving a rotation control signal on the mirror through the transceiver from the external electronic device or through the input unit; and
adjusting a direction in which the mirror is positioned according to the rotation control signal to adjust a direction in which the content is reflected.

2. The electronic device of claim 1, further comprising:
a rotatable actuator to adjust the direction in which the mirror is positioned,
wherein the processor is further configured to control for rotating the actuator according to the rotation control signal.

3. The electronic device of claim 1, further comprising a three-dimensional (3D) camera positioned in the second surface to sense a motion of a user to obtain raw image data.

4. The electronic device of claim 3, wherein the processor is further configured to control for setting a motion input region for sensing the motion of the user based on body information of the user.

5. The electronic device of claim 3, wherein the processor is further configured to control for setting a motion input region for sensing the motion of the user based on an application run on the external electronic device.

6. The electronic device of claim 3, wherein the processor is further configured to control for setting a motion input region for sensing the motion of the user based on a sensing direction of the 3D camera.

7. The electronic device of claim 3, wherein the processor is further configured to control for:
outputting the raw image data to the external electronic device, and
receiving a content processed using the raw image data from the external electronic device.

8. The electronic device of claim 3, wherein the processor is further configured to control for:
extracting skeleton data from the raw image data,
outputting the skeleton data to the external electronic device, and
receiving a content processed using the skeleton data from the external electronic device.

9. The electronic device of claim 3, wherein the processor is further configured to control for:
applying depth data of the raw image data to two-dimensional (2D) image data of the raw image data to generate 3D mapping data,
outputting the 3D mapping data to the external electronic device, and
receiving a content processed using the 3D mapping data from the external electronic device.

10. A method for controlling an electronic device comprising a housing, a holder positioned in a first surface of the housing to mount an external electronic device thereon, a beam projector positioned in a second surface of the housing, a mirror positioned between the first surface and the second surface to reflect a content outputted from the beam projector, an input unit provided in the housing, a transceiver communicable with the external electronic device, and a processor, the method comprising:
receiving the content from the external electronic device;
outputting the content using the beam projector;
receiving a rotation control signal on the mirror through the transceiver from the external electronic device or through the input unit; and
adjusting a direction in which the mirror is positioned according to the rotation control signal to adjust a direction in which the content is reflected.

11. The method of claim 10, further comprising sensing a motion of a user to obtain raw image data.

12. The method of claim 11, further comprising setting a motion input region for sensing the motion of the user based on body information of the user.

13. The method of claim 11, further comprising setting a motion input region for sensing the motion of the user based on an application run on the external electronic device.

14. The method of claim 11, further comprising setting a motion input region for sensing the motion of the user based on a sensing direction of a three-dimensional (3D) camera provided in the electronic device.

15. The method of claim 11, further comprising outputting the raw image data to the external electronic device.

16. The method of claim 15, further comprising receiving a content processed using the raw image data from the external electronic device.

17. The method of claim 11, further comprising extracting skeleton data from the raw image data.

18. The method of claim 17, further comprising outputting the skeleton data to the external electronic device and receiving a content processed using the skeleton data from the external electronic device.

19. The method of claim 11, further comprising applying depth data of the raw image data to two-dimensional (2D) image data of the raw image data to generate three-dimensional (3D) mapping data and outputting the 3D mapping data to the external electronic device.

20. The method of claim 19, further comprising receiving a content processed using the 3D mapping data from the external electronic device.
